(19) United States
(12) Patent Application Publication
(10) Pub. No.: US 2017/0162894 A1
(43) Pub. Date: Jun. 8, 2017

(54) CERAMIC CELL STRUCTURE

(71) Applicant: National Taipei University of Technology, Taipei City (TW)

(72) Inventors: Sea-Fue WANG, Taipei City (TW); Hsi-Chuan LU, Taipei City (TW)

(21) Appl. No.: 14/986,231

(22) Filed: Dec. 31, 2015

(30) Foreign Application Priority Data
Dec. 2, 2015 (TW) 104140398

(51) Int. Cl. H01M 8/1016; H01M 8/02; H01M 8/12

(52) U.S. Cl. CPC H01M 8/1016; H01M 8/12; H01M 8/02; H01M 2008/1293

(57) ABSTRACT

A ceramic cell structure includes an upper electrode layer, and a lower electrode layer. At least one electrolyte layer and at least one electron barrier layer are disposed between the upper electrode layer and the lower electrode layer. By changing the combination of the electrolyte layer and the, electron barrier layer disposed between the upper electrode layer and the lower electrode layer, the problem caused by conducting electricity via the electron which results in open circuit voltage drop and high temperature due to solely using electrolyte laser can be avoided. Conducting electricity via the electron can be prevented by adding the electron barrier layer with high ionic conductivity ratio. Besides, the ceramic cell can further increase the open circuit voltage and the power density above 700° C.

### BACKGROUND

1. Technical Field

The technical field relates to a ceramic cell structure, particularly to a ceramic cell structure added with an electron barrier layer. The electron barrier layer can overcome the disadvantages when using the electrolyte layer individually, as well as improve the cell performance,

2. Related Art

Solid oxide fuel cell (SOFC) is a fuel cell with features of high efficiency, simple structure, and easy operation, in the beginning, the SOFC is mainly used as an auxiliary power system in large buildings. Recently, with the improving of the SOFC technique, the SOFC can be used as independent and distributed power station. Compared to the centralized type power station, the distributed power generating system can not only avoid the energy loss during transferring electricity, but also prevent wide area power outage when the traditional centralized type power station is malfunction or the power transfer is cut off. Therefore, the distributed power generating system is a very ideal power generating means, which is now actually applied to large power plants, distributed power source, or electric cars, etc.

Under the high temperature operation of SOFC, the response of the electrode is quick. Therefore, no nobly metal is needed as a catalyst for the electrode, so the material cost can be reduced. However, on the other side, the over high operation temperature of the SOFC (larger than 800° C.) is easy to cause reaction of the electrode material and the electrolyte surface to increase the total resistance of the cell, as well as cause electrode peeling due to the huge difference of the thermal expansion coefficient of the electrode and electrolyte, which significantly reduces the life expectancy of the cell. Those problems mentioned above limit the development of the'SOFC, so reducing the operation temperature to medium low (500° C.-700° C.) is necessary. The conventional YSZ based Ni-YSZ anode needs relatively high operation temperature (700° C.-1000° C.) to obtain enough energy, to drive the oxygen ion to flow in the oxygen cavity. However, the high temperature may cause many problems (such as the high cost and short life of the equipment which uses high temperature type SOFC). In order to solve those problems, many researches have been done to replace the YSZ with a mixed SDC as anode material.

According to the research, the material of rare earth element doped ceria is a good oxygen ion conductor, which has high conductivity arid ion transport number at 500° C. Especially, the samarium oxide added with cerium oxide (SDC Sm_{X}Ce_{1-X}O₂₋₆)) is the best electrolyte material, and the conductive oxygen ion at 800° C. is three times than the YSZ. Ordinary electrolyte material should be sintered until reaching 95% theoretical density in, order to be used in the cell. However, the oxide added with cerium is still hard to become dense condition under high temperature sintering (larger than 1500° C.), and the diffusion of the cerium oxide becomes significant above 1450° C.

Thus, it is known that SDC has the advantages of high ionic conductivity at medium low temperature, low sintering temperature, and good matching for the cathode material and anode material. However, drawbacks of the SDC still exist, such as the easy reduction from Ce⁴⁺ to Ce³⁺ under reducing atmosphere. And since the electron conductivity of the electrolyte will increase, the open circuit voltage will drop accordingly.

Besides SDC, another new electrolyte, LSGM (LaₓSr_{1-X}Ga_{y}Mg_{1-y}O_{3-δ}) uses ABO₃ perovskite structure to replace the traditional fluorite structure, and can show more superior oxygen ion conductivity at 700′C than can that of YSZ (Y₂O₃)_{X}(ZrO₂)_{1-X}), so as to be more suitable for being used in SOFC. Since the LSGM shows good conductivity under low temperature, the LSGM can also be used as a good electrolyte. Besides, the LSGM also has the advantages of high open circuit voltage, stable chemical property under reducing atmosphere, being able to be used above 600°C. However, the LSGM also has the drawbacks of high sintering temperature, the ingredient being easy to change during, sintering, easy to react with anode or cathode material due to high activity,

If solely using SDC or LSGM as the electrolyte between the anode and cathode, the disadvantages mentioned above will be shown. Therefore, disadvantages can be found when using single type electrolyte material as the electrolyte layer between the upper electrode layer (normally anode) and lower electrode layer (normally cathode). For, example, as shown in US patent US2008/0261099 and US2009/0136821, the US2008/0261099 provides a solid oxide electrolyte layer between two electrode layers, and the electrolyte layer includes YSZ and ScSZ (such as Scandia ceria stabilized zirconia 10Sc1CeSZ). However, the US2008/0261099 has the problem of low ion conductivity ratio. Since the total conductivity is electron conductivity plus ion conductivity, electron conduction can thus exist under the low ion conductivity ratio. Moreover, the electron conduction will result in energy loss and cause the dropping of the open circuit voltage and generating high heat.

As to US 2009/0136821, the differences between this patent and the aforementioned patent lie in that the layers in the SOFC is not limited to three. As shown in FIG. 3, an additional layer 4 is disposed between the electrolyte 3 and the anode, 5, and another layer 6 is disposed between the electrolyte 5 and the cathode 7. The layers 4 and 6 can be made of material doped with ceria, samarium oxide, gadolinium oxide, and yttrium oxide. Except those materials mentioned above, the layers 4 and 6 can also be made of ceramic material such as stabilized zirconia, yttria stabilized zirconia (“YSZ”), scandia stabilized zirconia oxide (“SSZ”), cerium oxide, scandia oxide-stabilized zirconia (“SCSZ”), or the mixture thereof. Furthermore, the YSZ, SSZ, cerium oxide, scandia oxide-stabilized zirconia (SSZ) or the material doped with ceria (GDC) can be also included,

The main purpose of the additional layer 4 and the another layer 6 as disclosed in the US 2009/0136821 is to act like a chemical barrier layer or buffer layer to prevent the anode or the cathode reacting with the electrolyte layer cause the anode or cathode might react with the electrolyte layer under high heat processing. Even though US 2009/0136821 discloses the idea of interlayer, US 2009/0136821 still encounters the same problem as found in US 2008/0261099. Since the ion conductivity ratio of the electrolyte layer cannot reach 100%, US 2009/0136821 can cause energy loss due to the electron conducting. Therefore, even though multilayer structure is used, the open circuit voltage still drops and high heat is still generated due to conducting electricity via the electron if not considering the energy loss caused by the electron conducting,

Therefore, in order to overcome the aforementioned drawbacks, if at least one electron barrier layer which cuts the electron, conduction can be disposed between the upper electrode layer and the electrolyte layer, the lower electrode layer and the electrolyte layer, or any two of the electrolyte layers, the energy loss due to the electron conduction can be prevented, and the present invention should be the best solution for solving the conventional problems.

### BRIEF SUMMARY

The preferred embodiment of the present invention is related to a ceramic cell structure which is added with an electron barrier layer. Conducting electricity via the electron can be prevented by adding the electron barrier layer, thereby improving the cell performance.

The preferred embodiment of the present invention provides a ceramic cell structure, which includes an upper electrode layer and a lower electrode layer, and at least one electrolyte layer and at least one electron barrier, layer are disposed between the upper electrode layer and the lower electrode layer.

More specifically, the electrolyte layer is an oxide with Bi₂O₃ group, an oxide with CeCO₂ group, an oxide with ZrO₂ group, an oxide with ThO₂ group, an oxide with HfO₂ group, or an oxide with LaGaO₃ group.

More specifically, LaGaO₃ in the oxide with LaGaO₃ group is doped with element Sr, Mg, or Co.

More specifically, LaGaO₃ in the oxide with LaGaO₃ group is doped with element Sr or Mg.

More specifically, CeO₂ in the oxide with CeO₂ group is doped with element Sm, Gd, or La.

More specifically, ZrO₂ in the oxide with ZrO₂ group is stabilized with element Y or Sc.

More specifically, an ionic conductivity ratio of the electron harrier layer is greater than 95%.

More specifically, the electron barrier layer is an oxide with Bi₂O₃ group, an oxide with ZrO₂ group, an oxide with ThO₂ group, an oxide with HfO₂ group, or an oxide with LaGaO₃ group.

More specifically, LaGaO₃ in the oxide with LaGaO₃ group is doped with element Sr, Mg, or. Co.

More specific LaGaO₃ in the oxide with LaGaO₃ group is doped with element Sr or Mg.

More specifically, ZrO₂ in the oxide with ZrO₂ group is stabilized with element Y or Sc.

More specifically, a thickness of the electrolyte layer is between 0.1 μm and 50 μm.

More specifically, a thickness of the electron barrier layer is between 0.1 μm and 50 μm.

More specifically, the electrolyte layer is disposed between the upper electrode layer and the lower electrode layer; the electron barrier layer is disposed between the upper electrode layer and the electrolyte layer.

More specifically, the electrolyte layer is disposed between the upper electrode layer and the lower electrode layer; the electron barrier layer is disposed between the electrolyte layer and the lower electrode layer.

Another preferred embodiment of the present invention provides a ceramic cell structure, which includes an upper electrode layer and a lower electrode layer, and an electron barrier layer disposed between the upper electrode layer and the lower electrode layer; a first electrolyte layer disposed between the upper electrode layer and the electron barrier layer; and a second electrolyte layer disposed between the electron barrier layer and the lower electrode layer.

More specifically, the first electrolyte layer or/and the second electrolyte layer is an oxide with B i₂O₃ group, an oxide with CeO₂ group, an oxide with ZrO₂ group, an oxide with ThO₂ group, an oxide with HfO₂ group, or an oxide with LaGaO₃ group.

More specifically, LaGaO₂ in the oxide with LaGaO₃ group is doped with element Sr, Mg, or Co.

More specifically, LaGaO₃ in the oxide with LaGaO₃group is doped with element Sr or Mg.

More specifically, CeO₂ in the oxide with CeO₂ group is doped with clement Sm, Gd, or La.

More specifically, ZrO₂ in the oxide with ZrO₂ group is stabilized with element Y or Sc.

More specifically, an ionic conductivity ratio of the electron barrier layer is greater than 95%.

More specifically, the electron barrier layer is an oxide with Bi₂O₃ group, an oxide with ZrO₂ group, an oxide with ThO₂ group, an oxide with HfO₂ group, or an oxide with LaGaO₃ group.

More specifically, LaGaO₃ in the oxide with LaGaO₃ group is doped with element Sr, Mg, or Co.

More specifically, LaGaO₃ in the oxide with LaGaO₃ group is doped with element Sr or Mg.

More specifically, ZrO₂ in the oxide with ZrO₂ group is stabilized with element Y or Sc.

More specifically, a thickness of the first electrolyte layer is between 0.1 μm and 50 μm.

More specifically, a thickness of the second electrolyte layer is between 0.1 μm and 50 μm.

More specifically, a thickness of the electron barrier layer is between 0.1 μm and 50 μm.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a structural schematic view of a first preferred embodiment of the ceramic cell structure according to the present invention;

FIG. 2 is, a schematic flow chart of producing the ceramic cell structure according to the present invention;

FIG. 3A is a schematic diagram showing the relationship of the measured voltage/the power density and the current density;

FIG. 3B is a data schematic diagram of the first preferred embodiment of the ceramic cell structure after being measured;

FIG. 4A is schematic diagram showing the relationship of the conventional pure SDC measured voltage/power density and the current density;

FIG. 4B is a schematic diagram showing the measured data of the conventional pure SDC;

FIG. 5 is structural schematic view of a second preferred embodiment of the ceramic cell structure according to the present invention;

FIG. 6 is structural schematic view of a third preferred embodiment of the ceramic cell structure according to the present invention;

FIG. 7A is a three-dimensional structural schematic view of a fourth preferred embodiment of the ceramic cell structure according to the present invention;

FIG. 7B is a lateral structural schematic view of the fourth preferred embodiment of the ceramic cell structure according to the present invention;

FIG. 8A is a schematic diagram showing the relationship of the measured voltage the power density and the current density; and

FIG. 8B is a data schematic diagram of the first preferred embodiment of the ceramic cell structure after being measured.

### DETAILED DESCRIPTION

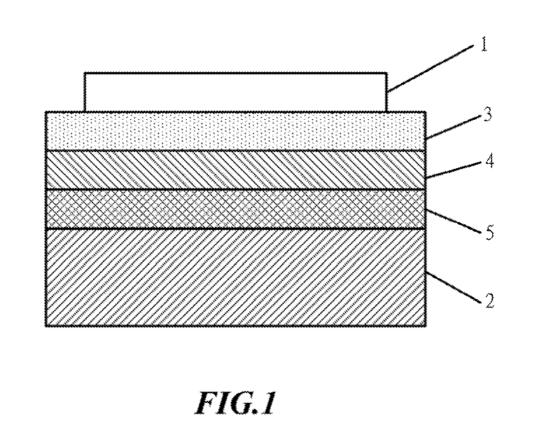

Referring to FIG. 1, the ceramic cell structure includes an upper electrode layer 1, a lower electrode layer 2, a first electrolyte layer 3, an electron barrier layer 4, and a second electrolyte layer 5. Wherein, the first electrolyte layer is disposed between the upper electrode layer 1 and the electron barrier layer 4, and the second electrolyte layer 5 is disposed between the electron barrier layer 4 and the lower electrode layer 2.

The upper electrode layer as disclosed in the present embodiment is cathode (also can be anode), and the lower electrode layer 2 is anode also can be cathode). The first electrolyte layer 3 and the second electrolyte layer 5 are formed by the following electrolyte material: an, oxide with Bi₂O₃ group, an oxide with CeO₂group, an oxide with ZrO₂ group, an oxide with ThO₂ group, an oxide with HfO₂ group, or an oxide with LaGaO₃ group. Wherein, the LaGaO₃ in the oxide with LaGaO₃ group can be doped with element Sr, Mg, or Co; the CeO₂ in the oxide with CeO₂ group can also be doped with element Sm, Gd, or La, and the ZrO₂ in the oxide with ZrO₂ group can be stabilized with element Y or Sc.

It will be the best if the material of the electrode layer has 100% ionic conductivity ratio, however, most of the electrode layer has lower than 98% ionic conductivity ratio. The whole conductivity is electron conductivity plus ionic conductivity (σ_{τ}=σᵢ=σₑ), and the perfect condition of the electrolyte layer is having 100% ionic conductivity. However, in the actual condition, the ionic conductivity ratio of the electrolyte layer

$$( {σ}_{i} \% = \frac{{σ}_{i}}{{σ}_{i} + {σ}_{e}} \times 100 \% )$$

is usually smaller than 98% (the electron conductivity is not 0%). Since conducting electricity by the electron can cause energy loss, the preferred embodiment of the present invention adds at least one electron barrier layer in addition to the electrolyte layer, so that when the electron conducts electricity, the electron barrier layer can block the electricity conduction of the electron. Under the best condition in the preferred embodiment of the present invention, the ionic conductivity ratio of the electron barrier layer

$$( {σ}_{i} \% = \frac{{σ}_{i}}{{σ}_{i} + {σ}_{e}} \times 100 \% )$$

should be equal or greater than 95% (such as 95%, 95.5%, 96%, 96.5%, 97%, 97.5%, 98%, 98.5%, 99%, 100%), but the present invention can also be applied with any electrolyte material having 0-100% ionic conductivity ratio.

The electron barrier layer 4 is formed by the following, electrolyte material: an oxide with Bi₂O₃ group, an oxide with CeO₂, group, an oxide with ZrO₂ group, an oxide with ThO₂ group, an oxide with HfO₂ group, or an oxide with LaGaO₃ group. Wherein, the LaGaO₃ in the oxide with LaGaO₃ group can be doped with element Sr, Mg, or Co; the CeO₂ in the oxide with CeO₂ group can also be doped with element Sm, Gd, or La, and the ZrO₂in the oxide with ZrO₂ group can be stabilized with clement Y or Sc.

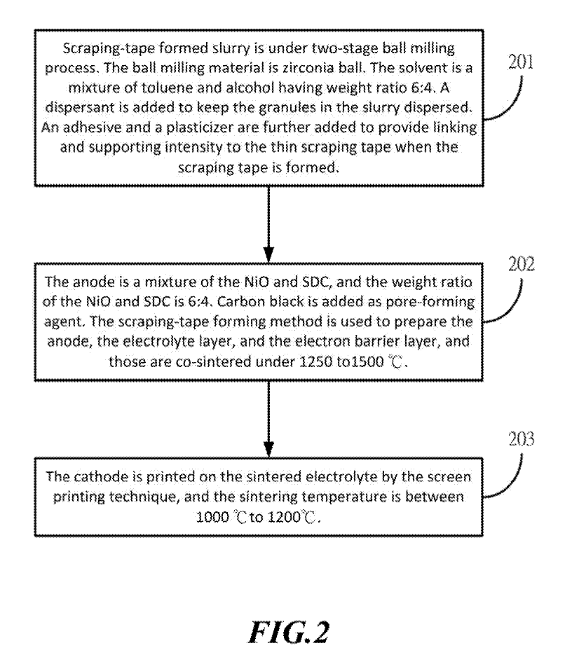

FIG. 2 shows a schematic flow chart of producing the ceramic cell structure according to the present invention. The processes are as follows:

Step 201: Scraping-tape formed slurry is under two-stage ball milling process. The ball milling material is zirconia ball The solvent is a mixture of toluene and alcohol having weight ratio 6:4. A dispersant is added to keep the granules in the slurry dispersed. An adhesive and a plasticizer are further added to provide linking and supporting intensity to the thin scraping tape when the scraping tape is formed.

Step 202: The anode is a mixture of the NiO and SDC, and the weight ratio of the NiO and SDC is 6:4, Carbon black is added as pore-forming agent. The scraping-tape forming method is used to prepare the anode, the electrolyte layer, and the electron barrier layer, and those are co-sintered under 1250 to1500° C.

Step 203: The cathode is printed on the sintered electrolyte by the screen printing technique, and the sintering temperature is between 1000° C. to 1200° C.

It is noted that, the aforementioned ceramic cell structure manufacturing process is merely one of the preferred embodiments, and is not limited thereto, such as blade molding method, sputtering method, coating method, screen printing method, and beading method. The manufacturing process of the present invention should overcome sintering matching, thermal expansion matching, chemical matching, and sintering shrinkage matching. The anode sintering temperature in the present invention is between 1250° C. to 1500° C., and the cathode sintering temperature is between 1000° C. to 1200° C. Besides, the thickness of the first electrolyte layer 3, the second electrolyte layer 5, and the electron barrier layer 4 is between 0.1 μm to 50 μm (0.1, 0.5. 2.5, 5, 7.5, 10, 12.5, 15, 17.5, 20, 22.5, 75, 27.5, 30, 37.5, 15, 37.5, 40, 42.5, 45, 47.5, 50). The thickness of different layers can be different, and the effect can be slightly different as well. The thickness can determine the characteristic of the layers. Theoretically, when the thickness is large to a specific extent (depends on the material), the power will decrease, but the stability and mechanical property of the electrolyte membrane will be better.

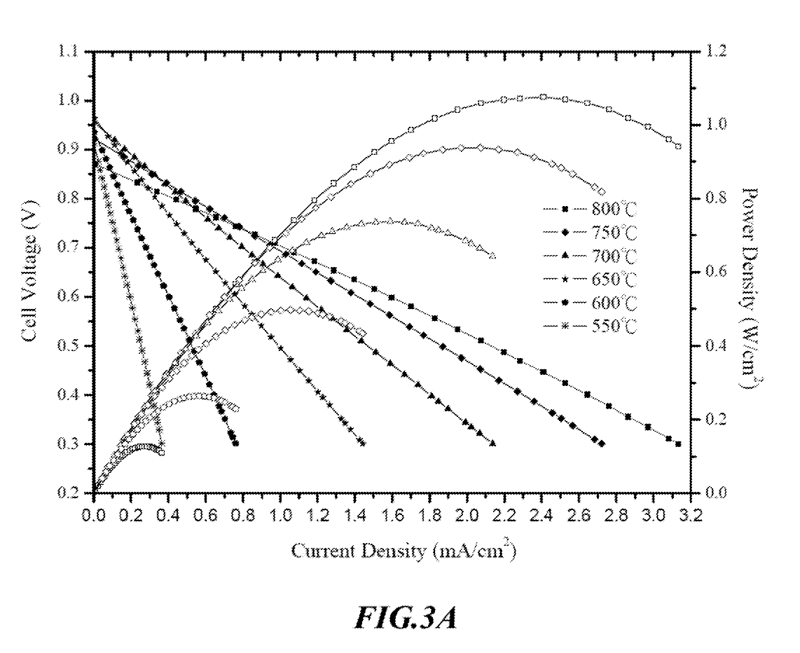

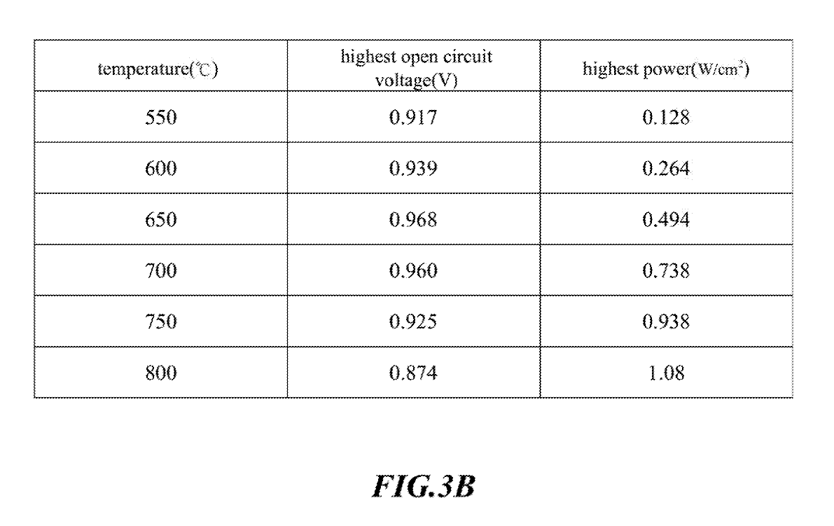

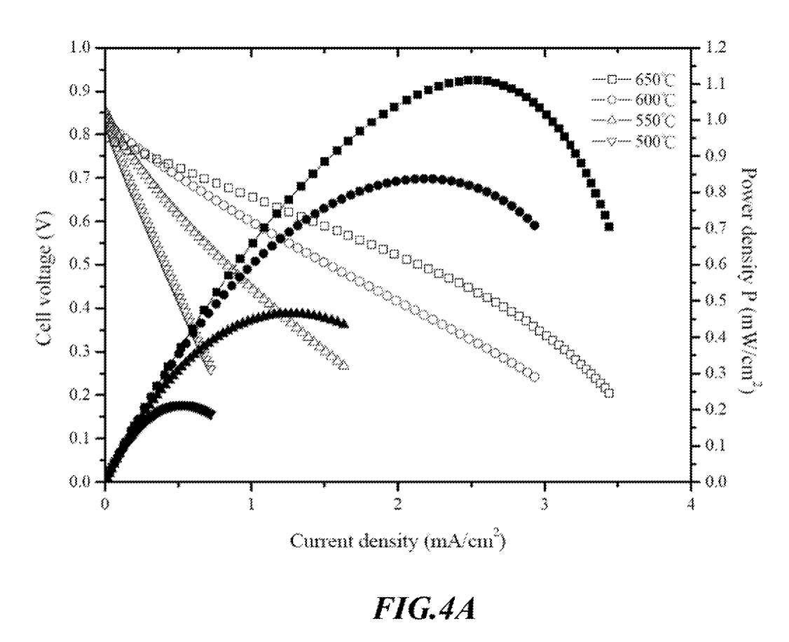

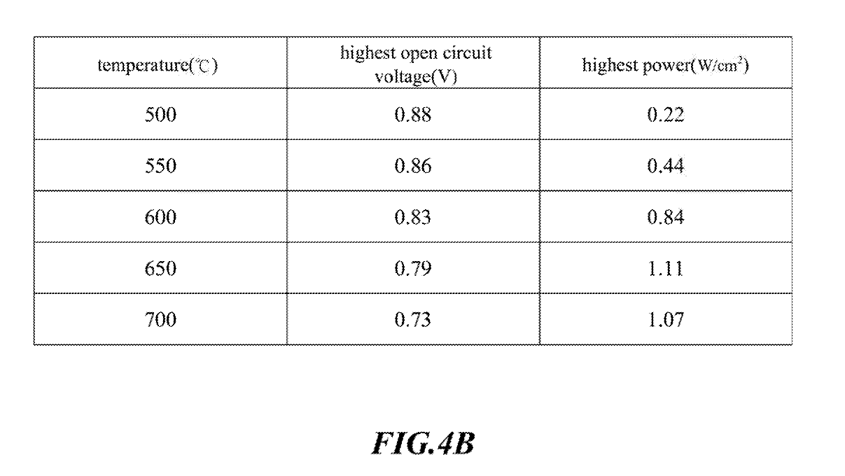

After the first manufacturing process (the first and the second electrolyte layers use SDC, and the electron barrier layer uses LSGM), electrical measurement is applied, and the results are shown as FIG. 3A and 3B. In order to be compared with the conventional pure SDC (cathode+SDC+anode), the electrical measurement results as shown in FIGS. 4A and 4B which use conventional pure SDC are compared with the electrical measurement result of the present invention (under different temperature, measuring the relationship of the voltage/the power density and the current density). The first embodiment of the present invention has six sets of experimental group; (550, 600, 650, 700, 750, 800° C.), and the conventional pure SDC has five sets of experimental groups (500, 550, 600, 650, 700° C.); the comparisons are as follows:

(1) In the six sets of experimental groups (550, 600, 650, 700, 750, 800° C.) of the first preferred embodiment of the present invention (as shown in FIG. 3A and FIG. 3B), the highest open circuit voltage thereof are all higher than that of the pure SDC (as shown in FIG. 4A and FIG. 4B). Take 650° C. as example, the voltage of the first embodiment of the present invention is 0.968V, and the pure SDC is 0.79V. It is obvious that the highest open circuit voltage of the first embodiment of the present invention is higher than that of the pure SOC.

(2) It can be seen from FIG. 4A, the pure SDC cannot keep for a long period of time above 650° C., while the first embodiment of the present invention can keep for a long period of time.

(3) Besides, for the power density, when comparing FIG. 3B and FIG, 4B, the highest power of the first embodiment of the present invention is at 800° C., 1.08 W/cm²; the highest power of the pure SDC is at 650° C., 1.11 W/cm².

(4) Based on the above, the advantages and disadvantages of the conventional pure SDC and the pure LSGM lie in that:
(a) The advantage of the pure SDC is highest ionic conductivity at medium low temperature, low sintering temperature, good matching of the cathode material and anode material.
(b) The disadvantage of the pure SDC is that the pure SDC: can be only used under 600° C., and the Ce⁴⁺ ion is easy to reduce to Ce³⁺ under reducing atmosphere, so that the electron conductivity will increase, and the open circuit voltage will be reduced.
(c) The advantage of the pure LSGM is high, open circuit voltage, stable chemical property under reducing atmosphere, and able to be used above 600° C.,
(d) The disadvantage of the pure LSGM is high sintering temperature; the ingredient is easy to change during sintering process; high activity and easy to react with anode or cathode material.

(5) According to the advantages and disadvantages of the aforementioned conventional pure SDC and the pure LSGM, and the testing results of FIG. 3A and FIG. 3B of the present invention, the combination of the electron harrier layer (LSGM) and the electrolyte layer (SDC) can overcome the disadvantages of the pure SDC and the pure LSGM while still keep all the advantages of the pure SDC and the pure LSGM. The drawback of solely using the electrolyte layer is causing the electro conduction of the electron, so the open circuit voltage will drop and high heat will be generated. However, according to, the measuring result, after adding the electron barrier layer, the problem of conducting electricity via the electron can be avoided, and the open circuit voltage, as well us the power density above 700° C. can be increased.

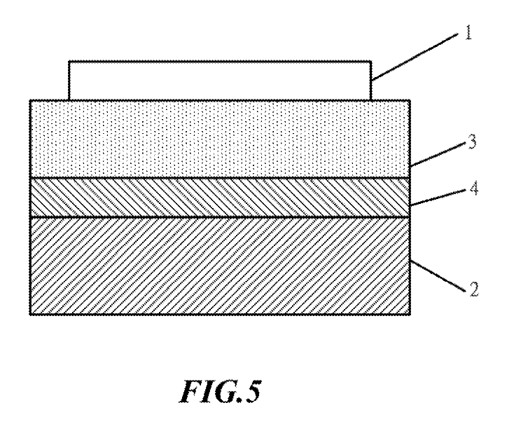

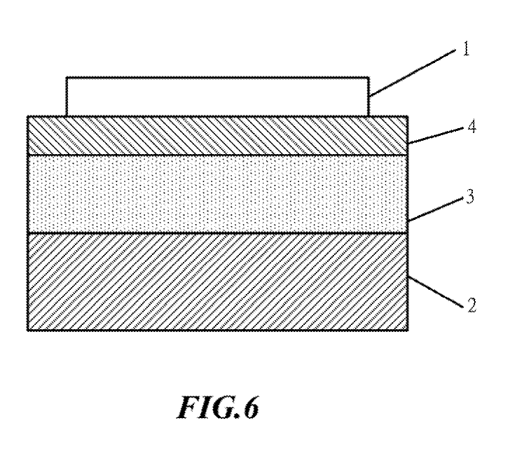

Besides the first preferred embodiment, a single electrolyte layer and a single electron barrier layer can also be used to achieve the same purpose. As shown in FIG. 5, the final structure only has a first electrolyte layer 3 and an electron barrier layer 4 (not having second electrolyte layer 5). Moreover, the structure of the first electrolyte layer 3 and the electron barrier layer 4 can be changed as shown in FIG. 6, the electron barrier layer 4 is provided between the upper electrode layer 1 and the first electrolyte layer 3. The structure disclosed in FIG. 5 and FIG. 6 can also have the same result as the first embodiment of the present invention, and the measuring result will not be discussed hereinafter.

The present invention combines the SDC and LSGM to compare with the single SDC or LSGM, it is obvious that the combination of the SDC and the LSGM can overcome the drawback and keep the advantage of solely using the SDC or LSGM. Therefore, the present invention selects different electrolyte material of the electrolyte layer and the electron barrier layer with different characteristic (if more than one electrolyte layer or electron barrier layer exist, same material might be used as well). Solely using the electrolyte layer might cause open circuit voltage dropping and high heat due to the electro conduction of the electron. However, after adding the electron barrier layer, the electro conduction of the electron can be avoided. Therefore, when selecting the electrolyte material for the electrolyte layer and the electron barrier layer, it is not considered in the present invention if the material used in the electron barrier layer cannot overcome the drawback of the material used in the electrolyte layer, and vice versa.

Furthermore, at least one electrolyte layer and one electron barrier layer can be used between the upper electrode layer 1 and the lower electrode layer 2. However, one electrolyte layer and multiple electron harrier layers, multiple electrolyte layers and one electron harrier layer, or multiple electrolyte layers and multiple electron harrier layers, can also be used between the upper electrode layer 1 and the lower electrode layer 2. The arrangement of the electrolyte layer and the electron barrier layer can be at least one of the following arrangements, or a combination thereof:

(1) One side of the electrolyte layer contacts the upper electrode layer 1, and the other side thereof contacts the electron barrier layer;

(2) One side of the electrolyte layer contacts the lower electrode layer 2, and the other side thereof contacts the electron barrier layer;

(3) One side of the electron barrier layer contacts the upper electrode layer 1, and the other side thereof contacts the electrolyte layer;

(4) One side of the electron barrier layer contacts the lower electrode layer 2, and the other side thereof contacts the electrolyte layer;

(5) When there are at least one electron barrier layer and at least one electrolyte layer disposed between the upper electrode layer 1 and the lower electrode layer 2, an electrolyte layer will be provided between at least two electron barrier layers, or an electron barrier layer is provided between;at least two electrolyte layers,

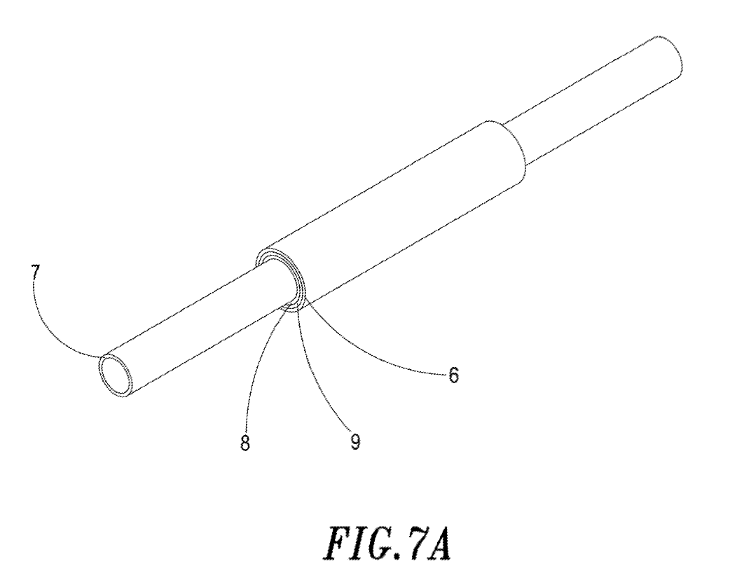

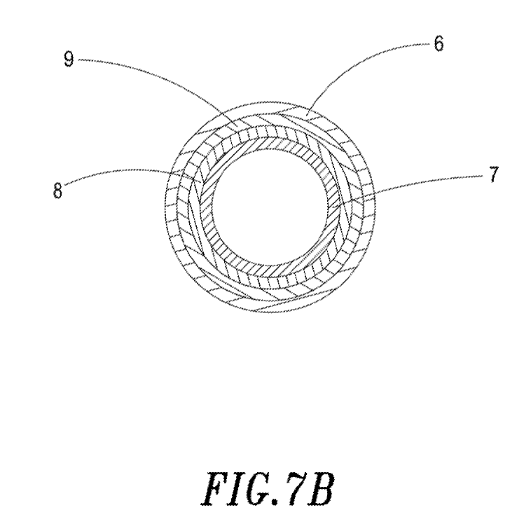

The aforementioned embodiment is shown as a flat plate structure, but can also be designed as tube structure, as shown in FIG. 7A and FIG. 7B. Wherein, the outermost part is an outer electrode layer 6 (LSCF and GDC is combined to be used as an cathode, but the outer electrode layer 6 can also be used as an anode), and the innermost part is an inner electrode layer 7 (NiO) and GDC is combined to be used as an anode, but the inner electrode layer 7 can also be used as an cathode). An electrolyte layer 8 (the material is GDC) and an electron barrier layer 9 (the material is LSGM) are provided between the outer electrode layer 6 and the inner electrode layer 7, wherein the electrolyte layer 8 is in contact with the inner electrode layer 7, and the electron barrier layer 9 is, in contact with the outer electrode layer 6.

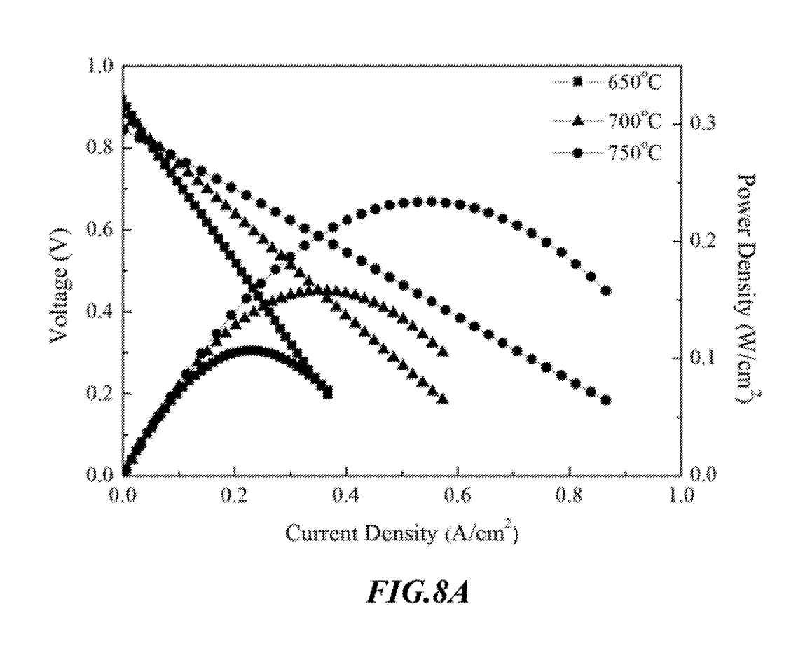

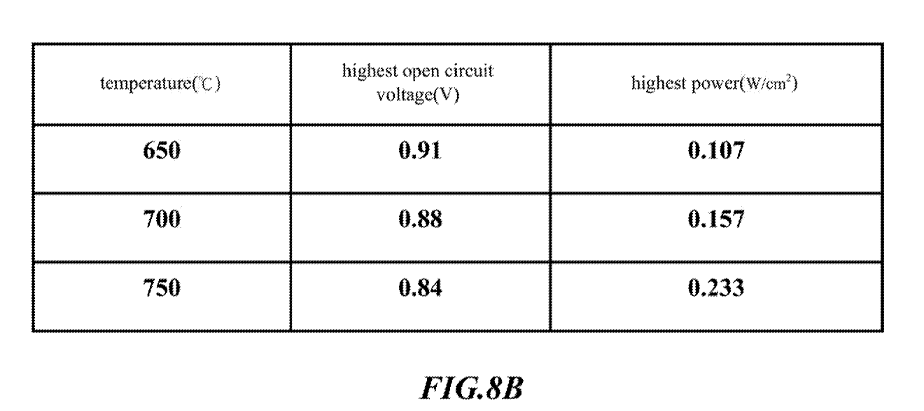

After measuring the tube shape structure as shown in fourth embodiment, a schematic diagram showing the data and relationship of the measured voltage/the power density and the current density is obtained. The experimental results of the fourth embodiment (FIGS. 8A and 8B) and the pure SDC (FIGS. 4A and 4B) are compared as follows.

(1) According to FIGS. 8A and 8B, the highest open circuit voltage for 650° C. is 0.9IV, which is significantly higher than that of pure SDC (as shown in FIGS. 4A and 4B). Furthermore, the highest open circuit voltage under 700° C. is 0.73V, but in the fourth embodiment, the highest voltage is 0.88V. Therefore, the highest open circuit voltage of the fourth embodiment is higher than that of the pure SDC.

(2) It can be known by comparing the FIG. 8A and FIG. 4A, the pure SDC cannot be kept for a long period of time above 650° C., while the fourth embodiment, as shown in FIG. 8A, can be kept for a long period of time above 650° C.

(3) Besides, as to the power density, it can be known from the comparison of FIG. 8B and FIG. 4B, the power density of the fourth embodiment is lower than the pure SDC. However, the data of the pure SDC as shown in FIG. 4A and FIG. 4B is measured in a flat plate structure; if the pure SDC is measured in a tube structure, the measured result of the fourth embodiment Will be definitely better than that of the pure SDC in tube structure.

Based on those described above, the purpose of the present invention can still be achieved when the present invention is formed in a tube structure. Even though the ceramic cell is shown in flat plate structure, the cell can also be designed as tube structure according to the fourth embodiment. The cell can be designed as different shape or structure according to different application, but the stacking structure layer inside the cell should be the same as described in the present invention, and thus not repeat hereinafter,

Besides, no matter how many layers, flat plate or tube structure the present invention has, it should be considered that if there will be a second phase formed between different layers when the electrolyte layer and electron barrier layer of the present invention are under sintering process. The thermal expansion coefficient of each layer should match to one another, so that cracking or separation of those layers will not happen after the cell is manufactured. Each layer should match in chemical properties, not only good binding ability, but also high oxygen ion transferring ability, so that the cell still keeps the high electro conductivity feature. Besides, the electron barrier layer 4 can be added into the cell only if the electron barrier layer 4 does not influence the working of the upper electrode and the lower electrode.

The advantages of the ceramic cell structure of present invention as compared to the conventional technique are as follows:

(1) The present invention can be added with electron barrier layer which is able to overcome the drawback of solely using the electrolyte layer, and improve the cell performance alter being processed.

(2) The ordinary electrolyte layer cannot 100% conduct the electricity via the ion, so the electron will conduct the electricity which results in energy loss. Therefore, the present invention uses electron barrier layer having high ionic conductivity ratio to combine with the electrolyte layer, thereby stopping conducting electricity via the electron.

(3) The drawback of solely using the electrolyte layer is causing the problem of conducting electricity via electron, which results in dropping of open circuit voltage and causes high temperature. However, after being added with the electron barrier layer in the present invention, the electricity conducting of the electron can be prevented, and the open circuit voltage, as well as the power density above 700° C. can be increased.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A ceramic cell structure comprising:
an upper electrode layer; and
a lower electrode layer,
wherein at least one electrolyte layer and at least one electron harder layer are disposed between the upper electrode layer and the lower electrode layer.

2. The ceramic cell structure according to claim 1, wherein the electrolyte layer is an oxide with Bi₂O₃ group, an oxide with CeO₂ group, an oxide with ZrO₂ group, an oxide with ThO₂ group, an oxide with HfO₂ group, or an oxide with LaGaO₃ group.

3. The ceramic cell structure according to claim 2, wherein LaGaO₃ in the oxide with LaGaO₃ group is doped with element Sr, Mg, or Co.

4. The ceramic cell structure according to claim 2, wherein LaGaO₃ in the oxide with LaGaO₃ group is doped with element Sr or Mg.

5. The ceramic cell structure according to claim 2, wherein CeO₂ in the oxide with CeO₂ group is doped with element Sm, Gd, or La.

6. The ceramic cell structure according to claim 2, wherein ZrO₂ in the oxide with ZrO₂ group is stabilized with element Y or Sc.

7. The ceramic cell structure according to claim 1, wherein an ionic conductivity ratio of the electron barrier layer is greater than 95%.

8. The ceramic cell structure according, to claim 1, wherein the electron barrier layer is an oxide with Bi₂O₃ group, an oxide with ZrO₂ group, an oxide with ThO₂ group, an oxide with HfO₂ group, or an oxide with LaGaO₃ group.

9. The ceramic cell structure according to claim 8, wherein LaGaO₃ in the oxide with LaGaO₃ group is doped with element Sr, Mg, or Co.

10. The ceramic cell structure according to claim 8, wherein LaGaO₃ in the oxide with LaGaO₃ group is doped with element Sr or Mg.

11. The ceramic cell structure according to claim 8, wherein ZrO₂ in the oxide with ZrO₂ group is stabilized with element Y or Sc.

12. The ceramic cell structure according to claim 1, wherein a thickness of the electrolyte layer is between 0.1 μm and 50 μm.

13. The ceramic cell structure according to claim 1, wherein a thickness of the electron harrier layer is between 0.1 μm and 50 μm.

14. The ceramic cell structure according to claim 1, wherein the electrolyte layer is disposed between the upper electrode layer and the lower electrode layer, the electron barrier layer is disposed between the upper electrode layer and the electrolyte layer.

15. The ceramic cell structure according to claim 1, wherein the electrolyte layer is disposed between the upper electrode layer and the lower electrode layer; the electron barrier layer is disposed between, the electrolyte layer and the lower electrode layer.

16. A ceramic cell structure comprising:
an upper electrode layer;
a lower electrode layer;
an electron barrier layer disposed between the upper electrode layer and the lower electrode layer;
a first electrolyte layer disposed between the upper electrode layer and the electron barrier layer; and
a second electrolyte layer disposed between the electron barrier layer and the lower electrode layer.

17. The ceramic cell structure according to claim 16, wherein the first electrolyte layer or/and the second electrolyte layer is an oxide with Bi₂O₃ group, an oxide with CeO₂ group, an oxide with ZrO₂ group, an oxide with ThO₂ group, an oxide with HfO₂ group, or an oxide with LaGaO₃ group.

18. The ceramic cell structure according to claim 17, wherein LaGaO₃ in the oxide with LaGaO₃ group is doped with element Sr, Ma, or Co.

19. The ceramic cell structure according to claim 17, wherein LaGaO₃ in the oxide with LaGaO₃ group is doped with element Sr or Mg.

20. The ceramic cell structure according to claim 17, wherein CeO₂ in the oxide with CeO₂ group is doped with element Sm, Gd, or La.

21. The ceramic cell structure according to claim 17, wherein ZrO₂ in the oxide with ZrO₂ group is stabilized with element Y or Se.

22. The ceramic cell structure according to claim 16 wherein an ionic conductivity ratio of the electron barrier layer is greater than 95%.

23. The ceramic cell structure according to claim 16, wherein the electron barrier layer is an oxide with Bi₂O₃ group, an oxide with ZrO₂ group, an oxide with ThO₂ group, an oxide with HfO₂ group, or an oxide with LaGaO₃ group.

24. The ceramic cell structure according to claim 23, wherein LaGaO₃ in the oxide with LaGaO₃ group is doped with element Sr, Mg, or Co.

25. The ceramic cell structure according to claim 23, wherein LaGaO₃ in the oxide with LaGaO₃ group is doped with element Sr or Mg.

26. The ceramic cell structure according to claim 23, wherein ZrO₂ in the oxide with ZrO₂ group is stabilized with element Y or Sc.

27. The ceramic cell structure according to claim 16, wherein a thickness of the first electrolyte layer is between 0.1 μm and 50 μm.

28. The ceramic cell structure according to claim 16, wherein a thickness of the second electrolyte layer is between 0.1 μm and 50 μm.

29. The ceramic cell structure according to claim 16, wherein a thickness of the electron barrier layer is between 0.1 μm and 50 μm.
